(19) United States
(12) Patent Application Publication
(10) Pub. No.: US 2025/0276376 A1
(43) Pub. Date: Sep. 4, 2025

(54) IN-SITU MODEL COMPARISON FOR ADDITIVE MANUFACTURING SYSTEMS

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,417

(22) Filed: Mar. 1, 2024

(51) Int. Cl. B22F 10/85; B22F 10/366; B33Y 10/00; B33Y 30/00; B33Y 50/02

(52) U.S. Cl. CPC B22F 10/85; B22F 10/366; B33Y 50/02; B33Y 10/00; B33Y 30/00

(57) ABSTRACT

An additive manufacturing system includes an energy delivery device and a powder delivery device configured to form an as-deposited layer on a build surface of the component. The system includes a topology monitoring system configured to capture data indicative of a position of a surface of the as-deposited layer, and also includes a computing device. The computing device is configured to receive the data and determine an actual position of the surface of the as-deposited. The computing device is configured to compare the actual position to a modeled position of the surface of the as-deposited layer. The computing device is further configured to determine a difference between the actual position and the modeled position of the as-deposited layer and control at least one of the energy delivery device or the powder delivery device based on the difference between the actual position and the modeled position of the as-deposited layer.

### TECHNICAL FIELD

The disclosure relates to additive manufacturing systems and techniques.

### BACKGROUND

Additive manufacturing systems generate three-dimensional structures through addition of material layer-by-layer or volume-by-volume to form the structure, rather than removing material from an existing component to generate the three-dimensional structure. Additive manufacturing processes may be advantageous in many situations, such as rapid prototyping, forming components with complex three-dimensional structures, or the like. In some examples, additive manufacturing processes may utilize powdered materials, and may melt or sinter the powdered material together in predetermined shapes to form the three-dimensional structures.

### SUMMARY

The disclosure describes additive manufacturing systems, and methods for operating additive manufacturing systems, that fabricate a component according to deposition parameters. An additive manufacturing system includes an energy delivery device that delivers energy to a build surface of a component to form a melt pool and a powder delivery device that directs a powder stream toward the melt pool to form an as-deposited layer on the build surface. The amount of material captured (e.g., the captured efficiency) or other material or process conditions may vary during an additive manufacturing process, which may lead to the actual dimensions (e.g., thickness) of an as-deposited layer departing from the desired dimensions. Accordingly, the final finished component may depart from specifications. For example, underbuilt and/or overbuilt portions or layers may lead to components that have actual dimension that are less than or greater than the desired dimensions.

Systems and techniques according to the present disclosure may address these and other problems by inclusion of a topology monitoring system and a computing device. The topology monitoring system may capture data indicative of a position of a surface of the as-deposited layer and send the data to a computing device. The computing device may determine an actual position of the surface of the as-deposited layer based on the received data from the topology monitoring system and compare the actual position of the surface of the as-deposited layer to a modeled position of the surface. The modeled position of the surface of the as-deposited layer may be part of a model stored by the computing device that includes dimensions of each layer of the plurality of layers that make up the component as well as the build strategy (e.g., deposition parameters of the powder delivery device and energy delivery device). The computing device may determine a difference between the actual position and the modeled position of the surface of the as-deposited layer and may control the powder delivery device and/or the energy delivery device based on the determined difference.

In some examples, the computing device may cause an adjustment to one or more parameters related to the powder delivery device (e.g., a carrier gas flow rate, a powder mass flow rate, or the like) and/or one or more parameters related to the energy delivery device (e.g., a scan speed, a focus, a power supplied to the energy delivery device, or the like). The computing device may determine a relationship between the determined difference and the deposition parameters that create the difference, such as by using machine learning techniques, that may be used to control the additive manufacturing system in the same or subsequent additive manufacturing processes. For example, the computing device may adjust one or more deposition parameters of the powder delivery device and/or the energy delivery device to reduce the difference between the actual position and the modeled position of the surface of the as-deposited layer. In some examples, the adjustment or adjustments may be made to a toolpath of a deposition head of which the powder delivery device and the energy delivery device are components. In this way, additive manufacturing systems described herein may, by in-situ comparison to a model component, control the powder delivery device and the energy delivery device to produce layers with improved build quality.

In some examples, the disclosure describes an additive manufacturing system which includes an energy delivery device configured to deliver energy to a build surface of a component to form a melt pool in the build surface of the component. The system includes a powder delivery device configured to direct a powder stream toward the melt pool to form an as-deposited layer on the build surface. The system includes a topology monitoring system configured to capture data indicative of a position of a surface of the as-deposited layer, and a computing device. The computing device is configured to receive the captured data from the topology monitoring system, determine an actual position of the surface of the as-deposited layer based on received data from the topology monitoring system, compare the actual position of the surface of the as-deposited layer to a modeled position of the surface of the as-deposited layer, determine a difference between the actual position and the modeled position of the as-deposited layer, and control at least one of the energy delivery device or the powder delivery device based on the difference between the actual position and the modeled position of the as-deposited layer.

In some examples, the disclosure describes a method for additive manufacturing. The method includes delivering, via an energy delivery device of an additive manufacturing system, energy to a build surface of a component to form a melt pool in the build surface of the component. The technique includes delivering, via a powder delivery device of the additive manufacturing system, a powder stream toward the melt pool to form an as-deposited layer on the build surface. The technique further includes receiving, by a computing device, data indicative of a position of a surface of the as-deposited layer from a topology monitoring system. The technique includes determining, by the computing device, an actual position of the surface of as-deposited layer based on the received data, and comparing, by the computing device, the actual position of the surface of the as-deposited layer to a modeled position of the surface of the as-deposited layer. The technique further includes determining, by the computing device, a difference between the actual position and the modeled position of the as-deposited layer. The technique also includes controlling, by the computing device and based on the determined difference between the actual position and the modeled position of the as-deposited layer, at least one of the powder delivery device or the energy delivery device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual block diagram illustrating an example additive manufacturing system that includes a topology monitoring system.

FIG. 1B is a conceptual block diagram illustrating example topology monitoring sensors and surface mapping modules of a computing device of an additive manufacturing system.

FIG. 2 is a process flow diagram illustrating an additive manufacturing technique which includes mass flux and heat flux monitoring and control through comparison to a model of the component technique.

FIG. 3 is a flowchart illustrating an example method for fabricating a component using comparison to a model.

FIG. 4A is a conceptual diagram illustrating an example machine learning model.

FIG. 4B is a conceptual diagram illustrating an example training process for a machine learning model.

FIG. 5 is a conceptual and schematic diagram illustrating a portion of an example an additive manufacturing system during an additive manufacturing technique.

FIGS. 6A-6D are conceptual and schematic diagram illustrating fabrication of an example component during an additive manufacturing technique that employs comparison to a model of the component and control based on the difference between the actual component and the model.

FIG. 7 is a flowchart illustrating an example method for fabricating a component using comparison to a component model.

### DETAILED DESCRIPTION

The disclosure generally describes techniques and systems for monitoring the position of a surface of an as-deposited layer during a blown powder additive manufacturing technique, such as a directed energy deposition (DED) technique, and comparing the determined position of the surface of the as-deposited layer to control fabrication of a component. During blown powder additive manufacturing, a component is built up by adding material in sequential layers, such that the final component is composed of a plurality of layers of material. In blown powder additive manufacturing techniques for forming components from metals or alloys, an energy source may direct energy at a substrate to form a melt pool, and a powder delivery device may deliver a powder to the melt pool. At least some of the powder at least partially melts and is joined to the melt pool and, thus, the substrate.

Challenges may arise when performing additive manufacturing techniques with additive manufacturing systems. For example, the amount of material captured by the melt pool, which may be called the capture efficiency, may vary between different layers and or areas of the build surface. For example, the travel speed of a deposition head along a toolpath changing between ends of a track and the center of the track may cause capture efficiency to change, or the complex interaction between the flow rate of carrier gases in the powder stream and coverage gases may change based on the particular position of the deposition head within the system, or the like. The changing amount of material in the powder stream captured by the melt pool may cause variation in the thickness of an as-deposited layer on the build surface, or may cause the thickness of the as-deposited layer to be greater than or less than the desired thickness. The underbuilding or overbuilding of layers may cause the dimensions of the component to fall outside a specification window, causing rework or potential discarding of the fabricated component.

In accordance with aspects of this disclosure, an additive manufacturing system includes a topology monitoring system. The topology monitoring system is configured to capture data indicative of a position of a surface of the as-deposited layer. The captured data may be delivered to and received by a computing device. The computing device may determine an actual position of the surface of the as-deposited layer based on the received data from the topology monitoring system. The computing device may compare the actual position of the surface of the as-deposited layer to a modeled position of the as-deposited layer and determine a difference between the actual position and the modeled position of the as-deposited layer. The computing device may adaptively control deposition based on the determined difference. For example, the computing device may, based on the determined difference between the actual position and the modeled position of the as-deposited layer, adjust one or more operational settings of the powder delivery device, the energy delivery device, or both. In some examples, the adjustment to the deposition parameters of the powder delivery device and/or the energy delivery device may reduce the determined difference between the actual position of the as-deposited surface and the modeled position of the surface of the as-deposited layer. In this way, systems and techniques according to the present disclosure may compare the actual component being manufactured to a model of the component in-situ (e.g., during the additive manufacturing process) to improve quality and/or reduce waste.

In some examples, substantially no difference between the actual position of the as-deposited surface and the modeled position. In other words, the specification window may be very tight or non-existent, and any determined difference between the actual position and the modeled position of the as-deposited layer may cause the computing device to stop the additive manufacturing process for inspection and/or rework. Alternatively, in some examples, a certain magnitude of difference between the modeled position and the actual position may be acceptable. In such examples, the computing device may determine that the difference exceeds a threshold (e.g., a non-zero threshold) for causing the as-deposited layer to fall outside a specification window. Responsive to determining that the difference exceeds a threshold difference, the computing device may control the energy delivery device and/or the powder delivery device to reduce the distance between the actual position of the as-deposited layer and the modeled position of the as-deposited layer in the same layer or in subsequent layers by adjusting one or more deposition parameters. Thus, the computing device may use the determined difference between the actual position of the as-deposited layer to select or adjust deposition parameters to produce a layer having the desired parameters. In this way, additive manufacturing systems may more accurately produce a layer, and ultimately a component, having the desired parameters compared to systems that do not use in-situ comparison of the actual position of a surface of an as-deposited layer to a modeled position to control deposition parameters.

The powder delivery device and the energy delivery device may be separate and discrete from each other, or may be combined as parts of a common deposition head. When parts of a common deposition head, the computing device may control the common deposition head to travel along a toolpath across the build surface to deposit a layer. In some examples, the computing device may also individually control the relative position of the powder stream to the melt pool by individually controlling the position of the powder delivery device and/or the energy delivery device within the common deposition head. In some cases, the deposition head may define a central longitudinal axis. The energy may be delivered coincident with or parallel to the central longitudinal axis. In some examples, at least part of the topology monitoring system may include a sensor disposed on the central longitudinal axis. In some examples, at least part of the topology monitoring system may include a sensor displaced from the central longitudinal axis in an “off-axis” position. In some examples, the topology monitoring system may include a combination of on-axis and off-axis sensors.

The topology monitoring system is configured to capture data indicative of the position of the surface of the as-deposited layer. In some examples, it is considered that the topology monitoring system may consist of a single sensor configured to determine a position of a single point on the as-deposited surface, and project the position of the remainder of the as-deposited surface based on the single point. Determining the position of the as-deposited surface based on a single point may be less computationally intensive than techniques which use multiple points on the surface of the as-deposited layer to determine the position of the as-deposited layer. However, in some examples, the topology monitoring system may include a single or multiple sensors (e.g., image sensors, laser sensors, or the like) configured to determine the position of a plurality of points on the surface of the as-deposited layer. Using multiple points on the surface (e.g., a point cloud) to determine the position of the surface may allow for more accurate and precise determine of the position of the as-deposited surface relative to methods which use only a single point on the surface.

For instance, the topology monitoring system may be configured to generate a three-dimensional scan of the surface of the as-deposited layer using one or more three-dimensional scanner devices. The one or more three-dimensional scanner device may include at least one of a computed tomography device, a structured-light device, a LIDAR device, or a time-of-flight camera device. Advantageously, generation of a three-dimensional scan of the surface of the as-deposited layer may allow for more precise selection and tailoring of deposition parameters to match the various points on the surface of the component being fabricated to the model of the component.

In some examples, the component model includes a computer-aided design (CAD) model that includes the final dimension of the component. The model may also include a position of each as-deposited layer in the plurality of layers that make up the finished component. The modeled position of each layer of the plurality of layers may include a similar three-dimensional scan of each layer (e.g., a modeled point cloud for each layer) for comparison to the captured data representative of the actual position of the as-deposited layer. Alternatively, a single point of along the z-axis (or other build direction axis) may be compared to the actual position to the as-deposited surface.

The component model may also include other information beyond the dimensions of the component and the dimensions of the individual layers that make up the component. For example, the component model may include a set of deposition parameters for each layer for the energy delivery device and the powder delivery device, which may collectively be called the build strategy. In other words, the model may include the operational settings of the system designed to build each modeled layer in the component model.

For example, the computing device may set parameters controllable by the powder delivery device that include one or more of a carrier gas flow rate, a powder mass flow rate, and a delivery nozzle angle. Similarly, the computing device may set parameters controllable by the energy delivery device to deposit a layer. The parameters controllable by the energy delivery device may include one or more of a focus of the energy delivery device, a power supplied to the energy delivery device, and the like. In examples where the powder delivery device and the energy delivery device are parts of a common deposition head, the deposition parameters include the travel speed of the deposition head along the toolpath, the amount of overlap between adjacent tracks, and any pauses, dwells, or intermittent movement of the deposition head, or the like. Responsive to determining that a difference in position exists between the modeled position of the as-deposited layer and the actual position of the as-deposited layer, the computing device may adjust one or more parameters controllable by the powder delivery device and/or may adjust one or more parameters controllable by the energy delivery device. The adjustment(s) may reduce a magnitude of the distance between the actual position of the surface of the as-deposited layer and the modeled position of the surface of the as-deposited layer.

The computing device may compare the actual component being built to the component model and adjust the deposition parameters in an iterative process to maintain control throughout the fabrication process. For example, the topology monitoring system may capture data indicative of the position of the as-deposited surface at the conclusion of the deposition of each layer, and the computing device may select and tailor the build strategy for the subsequent layer to apply the subsequent layer. The as-deposited surface becomes the new build surface, and the computing device may tailor deposition of the subsequent layer to account for any deviation from the model in the previously applied layer. For example, if the captured efficiency of the as-deposited layer was less than expected according to the design, the as-deposited layer may have less thickness than modeled, and the computing device may adjust the deposition parameter to apply the subsequent layer as a thicker layer than originally planned, such that the surface of the subsequent layer will better match the component model because the reduced captured efficiency is accounted for.

Additionally, or alternatively, the computing device may compare and adjust deposition parameters during deposition of a layer rather than only at conclusion of a layer. For example, the computing device may perform comparison and adjustment based on expiration of a duration of time (e.g., every second, every minute, or the like). In this way, adjustment of deposition parameters may be completed during deposition of a layer, which may improve responsiveness to unexpected changes in the capture efficiency or other process parameters.

The computing device may control (e.g., adjust parameters) of the powder delivery device and/or the energy delivery device in response to a determined difference between the actual position of the as-deposited layer and the modeled position of the as-deposited layer in one or more ways. In some examples, preset adjustments may be conducted, for example iteratively until difference is eliminated. In some examples, the computing device may store a lookup table which stores both adjustments to settings of the powder energy delivery device and/or the energy delivery device. The computing device may perform an adjustment to the powder delivery device and/or the energy delivery device based on the recommended adjustment from the lookup table. As one example, the computing device may determine that the position of the surface of the as deposited layer is too low, meaning that the as-deposited layer is less thick than the layer is in the component model. Responsive to the determination, the computing device may output a signal that causes the travel speed of deposition head down the toolpath to reduce, or may output a signal that causes an increase of the powder mass flow rate in the powder stream, or output a signal that causes an increase of the amount of overlap between adjacent tracks, or combinations thereof, or the like.

In one or more examples of the disclosure, the computing device may determine, via a machine learning model that takes the data from the topology monitoring system as input, one or more deposition parameters of the powder delivery device and/or the energy delivery device using one or more machine learning techniques. In this way, the computing device may be trained to execute adjustments to the settings of the powder delivery device and/or the energy delivery device based on previous adjustments that were made and the resulting outcomes of such adjustments.

Although generally described herein as capturing data indicative of the position of the surface of the as-deposited layer, it is considered that the data captured by the topology monitoring system may be indicative of the position of the build surface. For example, if the as-deposited layer is only partially completed, data indicative of the top surface of the build (e.g., image data) may include data indicative of both the build surface and the surface of the as-deposited layer. In some examples, the computing device may be configured to determine and recognize areas where the position of the build surface is being captured (e.g., those portions on the top surface of the component which have not been visited by the deposition head) and account for the fact that the captured data is of two different layers. For example, an edge of the as-deposited layer may be identified in the captured data, or a temperature difference may be sensed between the surface of the as-deposited layer and the build surface. Recognizing the difference between the two different layers, the computing device may compare the actual position of the build surface to the modeled position of the build surface in areas where data indicative of the build surface is captured, and compare the actual position of the as-deposited layer to the modeled position of the as-deposited layer in areas where data indicative of the as-deposited layer is captured.

Additive manufacturing systems and techniques of the present disclosure may be used to form any suitable component. For example, the additively-manufactured component may be a component of a gas turbine engine (e.g., a blade, a blisk, etc.), or an additively-manufactured coating on a gas turbine engine component. Forming components or coatings of gas turbine engines in this way may reduce material waste and rework, and/or provide for increased quality relative to other gas turbine engine components formed by other manufacturing processes.

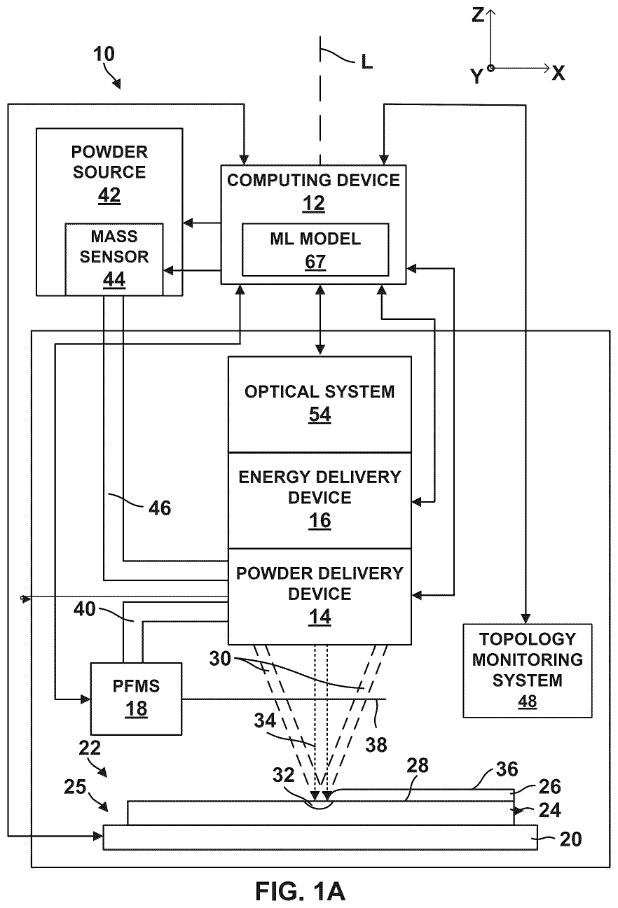

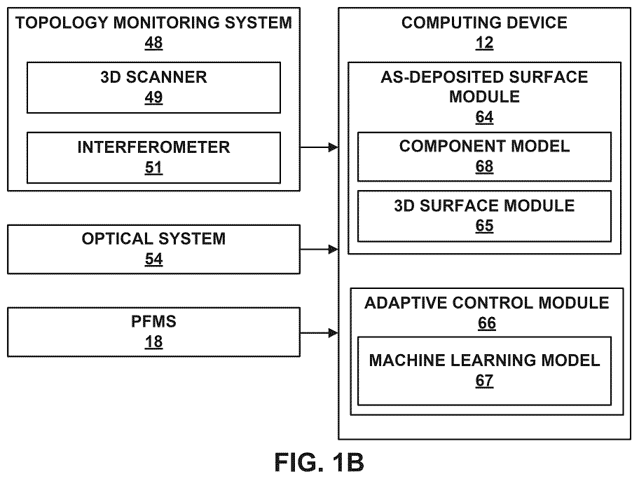

FIG. 1A is a conceptual block diagram illustrating an example additive manufacturing system 10 configured to monitor a gas flow during an additive manufacturing technique. In the example illustrated in FIG. 1A, additive manufacturing system 10 includes a computing device 12, a powder delivery device 14, an energy delivery device 16, a powder flow monitoring system (PFMS) 18, an optical system 54, a stage 20, a powder source 42, a powder source mass sensor 44, and a topology monitoring system 48.

Stage 20 is configured to position component 22 during an additive manufacturing process. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. Stage 20 may be configured to selectively position and restrain component 22 in place relative to stage 20 during manufacturing of component 22. In some examples, component 22 may be considered to be in-situ during any time when component 22 is mechanically supported by stage 20.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream. System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1A, for at least part of flow path 46 between powder source 42 and nozzles of powder delivery device 14, flow path 46 may split into multiple, parallel sections, e.g., one for each nozzle. Further, although not shown in FIG. 1A, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder and gas flow, such that the combined powder and gas flow defines powder stream 30 focused at a focus plane. The gas flow may include an inert gas, such as argon or nitrogen gas, that maintains an inert atmosphere near melt pool 32. As powder delivery device 14 is movable in the z-axis shown in FIG. 1A relative to component 22, the focal plane of powder delivery device 14 also may be movable in the z-axis relative to component 22, such that the focus plane may be controlled to be substantially coincident with build surface 28.

In some examples, powder delivery device 14 may be mechanically coupled or attached to energy delivery device 16 to facilitate delivery of powder stream 30 and energy 34 for forming melt pool 32 to substantially the same location adjacent to component 22. In some examples, powder delivery device 14 and energy delivery device 16 may be parts of a common deposition head. Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, and/or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22. In some examples, energy delivery device 16 may be translatable and/or rotatable in three dimensions.

As shown in FIG. 1A, energy delivery device 16 may be arranged or configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder delivery nozzle(s) for forming powder stream 30 and directing powder stream 30 toward build surface 28. At least some of the powder in powder stream 30 may impact a melt pool 32 in component 22, and at least some of the powder that impacts melt pool 32 may be joined to component 22.

During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24, forming as-deposited layer 26. Melt pool 32 cools as energy 34 is no longer delivered to that location of first layer 24 (e.g., due to energy delivery device 16 scanning energy 34 over the surface of first layer 24). In this way the deposition head may traverse across build surface 28 (e.g., back and forth across build surface 28) depositing tracks of material which form as-deposited layer 26.

System 10 may include both mass flow monitoring and heat flow monitoring. To provide mass flow monitoring, system 10 may include powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28. The imaging device of PFMS 18 is configured to image at least some of the illuminated powder. The imaging device may have a relatively high data acquisition speed (e.g., frame rate), such greater than 1000 Hz.

To provide heat flow monitoring, system 10 may include one or more thermal image sensors configured to image at least a portion of melt pool 32 to detect parameters, such as size, temperature, or shape, of melt pool 32. For example, a thermal sensor may be communicatively coupled to optical system 54 for observing thermal emissions around melt pool 32 and the same or a different thermal camera may monitor a size and/or temperature of melt pool 32. Optical system 54 may include an imaging device and an associated optical train, which senses emissions at or near component 22 during the additive manufacturing technique. For example, optical system 54 may include a visible light imaging device, an infrared imaging device, or an imaging device that is configured (e.g., using a filter) to image a specific wavelength or wavelength range. The optical train may include one or more reflective, refractive, diffractive optical components configured to direct light to the imaging device. For example, the optical train may be configured to direct light from near component 22 and/or melt pool 32 to the imaging device.

System 10 further includes a topology monitoring system 48. Topology monitoring system 48 is configured to capture data indicative of a position of surface 36 of as-deposited layer 26. In some examples, topology monitoring system 48 may include a single sensor which captures data indicative of a position of a single point on surface 36. Additionally, or alternatively, topology monitoring system 48 may include a single or multiple sensors configured to determine a position of a plurality of points on surface 36 (e.g., as a point cloud).

By determining the actual position of surface 36 of as-deposited layer 26, data captured by topology monitoring system 48 may be used to monitor an amount of powder captured by melt pool 32. For example, system 10 may, by imaging melt pool 32 and the added material, allow the mass to be quantified (e.g., by computing device 12) using the dimensions of the added material and density of the material (powder). In some examples, topology monitoring system 48 may include a laser and a sensor (e.g., an imaging device), which senses laser light reflected by the structure being imaged (e.g., melt pool 32 and the added material). The laser may have a defined wavelength, which may affect the resolution of the topology monitoring system 48. In some examples, the wavelength and sensor may be selected such that the resolution of topology monitoring sensor 48 is a great as about 10 microns (e.g., about 6 microns).

In some examples, at least one sensor of topology monitoring system 48 may be positioned substantially directly above component 22, for example on central longitudinal axis L, and may include an interferometer, which provides depth information based on the time from outputting a laser pulse to the sensing of the reflected light. Additionally, or alternatively, topology monitoring system 48 may include at least one sensor displaced from central longitudinal axis L. As such, topology monitoring system may include at least one sensor may be positioned at an offset with respect to component 22 such that the sensor senses depth information without using an interferometer.

Topology monitoring system 48 may capture data that allows computing device 12 to generate a three-dimensional scan of surface 36 from the captured data. For example, topology monitoring system 48 may include at least one of a computed tomography (CT) device, a structured-light device, a LIDAR device, or a time-of-flight device. In some examples, topology monitoring system 48 may include a combination of sensors and devices based on one or more of these technologies.

In some examples, topology sensors of topology monitoring system 48 may be integral with system 10, e.g., disposed within the enclosure or working area of system 10. In other examples, topology monitoring system 48 may be an add-on component to system 10. For example, the enclosure in which the additive manufacturing technique is performed may include a transparent window, and topology sensor 48 may be positioned outside of the enclosure and may image component 22 through the transparent window.

Topology sensor(s) of topology monitoring system 48 may capture data from a stationary position within system 10, and may be configured to determine the position of surface 36 based on the distance from surface 36 to the stationary sensor. Additionally, or alternatively, topology monitoring system 48 may include one or more sensors that are configured to move within system 10. For example, a topology sensor of topology monitoring system 48 may be part of the deposition head that travels along the toolpath to scan energy 34 and direct powder stream 30 to melt pool 32. In such cases, the mobile sensor may capture data indicative of surface 36, and computing device 12 may determine the position of surface 36 based on the position of the deposition head and the distance from surface 36 to the sensor.

Computing device model 12 includes machine learning (ML) model 67. In some examples, ML model 67 may receive data indicative of surface 36 captured by topology monitoring system 48 as inputs to the machine learning model. In addition to data topology monitoring system 48, ML model 67 may receive data from optical system 54, PFMS 18, and/or other parameters (settings of powder delivery device 14, settings of energy delivery device 16, or other sensed data or settings of system 10).

Computing device 12 is configured to control components and operation of system 10 and may include, for example, a desktop computer, a laptop computer, a workstation, a server, a mainframe, a cloud computing system, or the like. Computing device 12 may be communicatively coupled to, and configured to control, powder delivery device 14, energy delivery device 16, PFMS 18, optical system 54, stage 20, powder source 42, powder source mass sensor 44, and/or topology monitoring system 48 using respective communication connections. Although FIG. 1A illustrates a single computing device 12 and attributes all control and processing functions to that single computing device 12, in other examples, system 10 may include multiple computing devices 12, e.g., a plurality of computing devices 12.

Computing device 12 may be configured to control operation of powder delivery device 14, energy delivery device 16, adjustable z-stage 40, and/or stage 20, to position component 22 relative to powder delivery device 14, energy delivery device 16, PFMS 18, and/or topology monitoring system 48 during additive manufacturing processes. For example, as described above, computing device 12 may control stage 20 and powder delivery device 14, energy delivery device 16, and/or adjustable z-stage 40 to translate and/or rotate along at least one axis to position component 22 relative to powder delivery device 14, energy delivery device 16, PFMS 18, and/or topology monitoring system 48. Positioning component 22 relative to powder delivery device 14, energy delivery device 16, PFMS 18, and/or topology monitoring system 48 may include positioning a predetermined surface (e.g., build surface 28 to which material is to be added) of component 22 in a predetermined orientation relative to powder delivery device 14, energy delivery device 16, and/or topology monitoring system 48.

Computing device 12 may be configured to control system 10 to deposit layers 24 and 26 to form component 22 based on a set of deposition parameters. The set of deposition parameters may include energy, feed, and motion parameters that are configured to produce layers 24, 26, having various physical parameters, such as a thickness of layers 24, 26, (collectively “layers 25”) and a density of layers 25. For example, the set of deposition parameters may include power supplied, beam diameter (focus), beam profile, and wavelength of energy delivery device 16; powder feed rate and gas feed rate of powder delivery device 14; scan speed and deposition path of stage 20 relative to energy delivery device 16 and powder delivery device 14; or any other operating parameters that may affect an amount and/or quality of material formed as layers 25.

Computing device 12 may be configured to select deposition parameters that are configured to generate layers 25 according to the desired physical parameters. As shown in FIG. 1A, component 22 may include a base layer 24 and as-deposited layer 26, although many components may be formed of additional layers, such as tens of layers, hundreds of layers, thousands of layers, or the like. Component 22 in FIG. 1A is simplified in geometry and the number of layers compared to many components formed using additive manufacturing techniques. Although techniques are described herein with respect to component 22 including base layer 24 and as-deposited layer 26, the technique may be extended to components 22 with more complex geometry and any number of layers 25.

To form component 22, computing device 12 may control powder delivery device 14 and energy delivery device 16 according to the set of operating parameters to form, on build surface 28 of base layer 24 of material, an as-deposited layer 26 of material. Computing device 12 may control energy delivery device 16 to deliver energy beam 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32.

Computing device 12 may control powder delivery device 14 and energy delivery device 16 to move energy 34 and powder stream 30 along build surface 28 in a pattern until as-deposited layer 26 is complete. After completion of as-deposited layer 26, computing device 12 may then control a z-axis position of stage 20 and/or powder delivery device 14 and energy delivery device 16 such that melt pool 32 will be formed on surface 36, and this surface will be the build surface for subsequent layers.

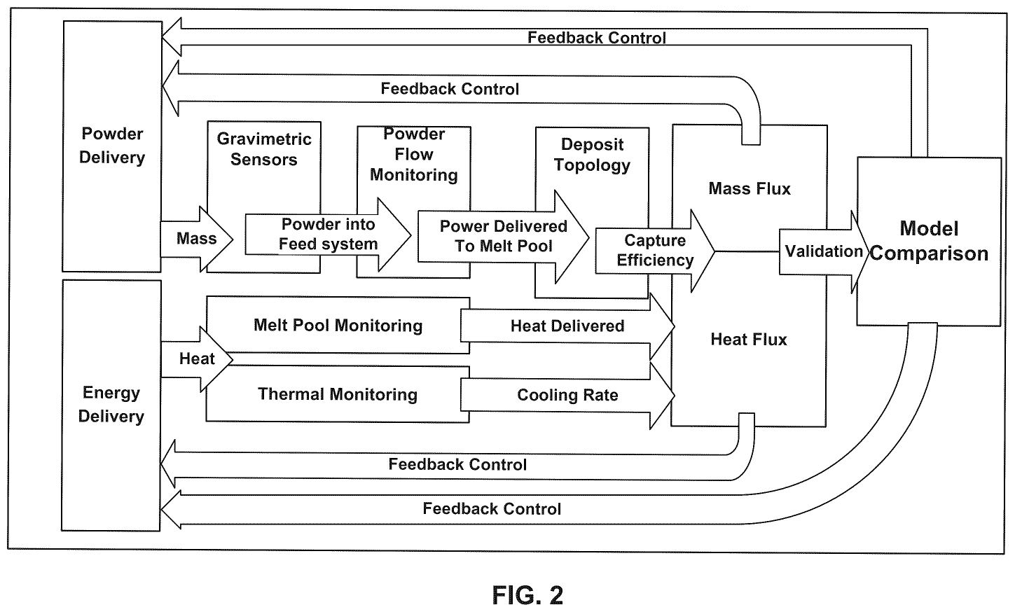

As mentioned above, system 10 may be configured with various in-situ monitoring techniques, including mass flux monitoring, heat flux monitoring, gas flow monitoring, and dimensional monitoring, to control an additive manufacturing process. FIG. 2 is a process flow diagram illustrating a mass flux and heat flux monitoring and control technique. The technique of FIG. 2 may be implemented by system 10 of FIG. 1A and will be described with concurrent reference to FIG. 1A.

Computing device 12 may be configured to control a powder feed rate output by powder source 42 (see top left of FIG. 2). For instance, computing device 12 may be configured to control an agitator of powder source 42, a gas flow rate of gas flowing through powder source 42, a position of one or more valves within flow path 46, or the like to control a powder feed rate output by powder source 42. Computing device 12 may be configured to receive data from one or more mass flow monitoring sensors, including PFMS 18 and/or powder source mass sensor 44. Data received from powder source mass sensor 44 indicates a mass flow of powder from powder source 42 to powder delivery device. Data from PFMS 18 indicates a mass flow of powder in powder stream 30 between powder delivery device 14 to adjacent melt pool 32.

Computing device 12 may calculate one or more mass flow-related metrics based on the data received from PFMS 18 and powder source mass sensor 44. For example, one or more computing devices 12 may determine a capture efficiency by determining a fraction or percentage of powder from powder stream 30 that is captured by melt pool 32 and added to component 22, e.g., by dividing the powder mass captured by melt pool 32 into the mass flow determined based on data received from PFMS 18. Further, computing device 12 may determine an overall mass flux using the data received from PFMS 18 and/or powder source mass sensor 44. One or more computing devices 12 then may use the overall mass flux as an input to the control algorithm used to control the powder feed rate output by powder source 42 (see top left of FIG. 2).

Similarly, computing device may be configured to control energy delivery device 16 to deliver energy beam 34 to base layer 24 to establish a given heat input (see bottom left of FIG. 2). For example, one or more computing device 12 may control one or more operating parameters of energy delivery device 16, such as intensity, pulse rate, pulse width, or the like; one or more positional parameters related to energy delivery device 16, such as dwell time at a location, a movement rate relative to base layer 24, an overlap between adjacent passes of energy 34 across base layer 24, a pause time between adjacent passes of energy 34 across base layer 24, or the like to control heat input to system 10 (e.g., to melt pool 32 and component 22).

Computing device 12 may be configured to receive data from one or more heat sensors, at least one of which may be a melt pool monitor (e.g., a thermal camera), which may be housed within optical system 54. Computing device 12 may determine a cooling rate and associated heat from using data from optical system 54 and may determine a heat input into component using a size and/or temperature of melt pool 32 as observed by the melt pool monitor. Computing device 12 may be configured to determine an overall heat flux using these data. Computing device 12 may then use the overall heat flux as an input to the control algorithm used to control the energy delivery by energy delivery device 16 (see top left of FIG. 2).

Computing device 12 may be configured to the actual position of surface 36 of as-deposited layer 26 during the build, and compare the actual position of surface 36 to a modeled position of surface 36 to validate that system 10 is operating within control. For example, topology monitoring system 48 may capture data indicative of a position of surface 36, and computing device 12 may determine the actual position of surface 36 based on the captured data. Computing device 12 may also store a model of component 22. The model of component 22 may include a CAD file including final dimensions of component 22, and the component model may further store the dimensions (e.g., thickness) of each layer of the plurality of layers 25 that make up component 22. Additionally, in some examples, the component model may include the deposition parameters (e.g., operational setting of powder delivery device 14 and/or energy delivery device 16) that result in the desired dimensions of each layer.

Computing device 12 may compare the actual dimensions of layer 26 by determining the position of surface 36, and may compare the actual position of surface 36 to the position of surface 36 stored within the component model. If computing device 12 determines that the actual position of surface 36 matches the modeled position of surface 36 (e.g., does not exceed a threshold difference) the computing device 12 may cause the process to continue based on the current build strategy, that is, according to the deposition parameters stored within the component model. However, if computing device 12 determines that the difference between the actual position of surface 36 and the modeled position of surface 36, computing device 12 may adjust control of one or both of powder delivery device 14 and energy delivery device 16. For instance, computing device 12 may be configured to control a carrier gas flow rate, a powder mass flow rate, and/or a delivery nozzle angle of powder delivery device 14 and/or a focus, a power supplied, a pulse rate, a wavelength, or the like of energy 34 of energy delivery device 16 to reduce the determined difference between the actual and modeled position of surface 36. In this way, system 10 may include topology monitoring by topology monitoring system 48 to reduce or eliminate deposition of layer 26 at a thickness that falls outside a specification window, or may adjust a thickness of a subsequent layer to bring the build back within the specification window, Thus, topology monitoring system 48 and the associated control techniques may improve build quality of component 22. In some examples, computing device 12 may control powder delivery device and/or energy delivery device 16 based at least partially on output(s) from ML model 67, as will be further described below.

FIG. 1B is a conceptual block diagram illustrating example topology monitoring sensors which include 3D scanner 49 and interferometer 51 of topology monitoring system 48. FIG. 1B also illustrates topology monitoring analysis and control modules of computing device 12 of additive manufacturing system 10. Computing device 12 may be communicatively coupled to topology monitoring system 48, optical system 54, and PFMS 18 to receive data from topology monitoring system 48, optical system 54, and PFMS 18.

Topology monitoring system 48 includes one or more sensors configured to capture data representative of a portion of surface 36. In some examples, the one or more sensors may generate sensor data representative of the position of surface 36 in a portion of system 10, and send the sensor data to computing device 12. In the example of FIG. 1B, topology monitoring system 48 includes 3D scanner 49 and interferometer 51. 3D scanner 49 is a three-dimensional scanner to capture image data that may be used by computing device 12 to generate a three-dimensional scan of surface 36. 3D scanner 49 may be a computed tomography (CT) device, a structured-light device, a LIDAR device, or a time-of-flight camera device. Interferometer 51 may include a laser and a sensor which provides depth information based on the time from outputting a laser pulse to the sensing of the reflected light. However, topology monitoring system 48 may include other sensors that are configured to capture data indicative of the position of the same or other portions of surface 36 using the same or other modes. Computing device 12 may be configured to receive data from the one or more sensors of topology monitoring system 48.

In addition to data from topology monitoring system 48, computing device 12 may receive data indicative of various parameters related to powder flow, energy flow, gas flow, and the like of system 10. For example, PFMS 18 may be configured to detect one or more parameters of system 10 related to powder flow, generate sensor data, and send the sensor data to computing device 12. Sensor data from PFMS 18 may indicate a mass flow of powder in powder stream 30 between powder delivery device 14 to adjacent melt pool 32. Similarly, optical system 54 may detect one or more parameters related to energy flow, generate sensor data, and send the sensor data to computing device 12. Sensor data from optical system 54 may indicate a flow of energy in energy beam 34 between energy delivery device 16 and melt pool 32.

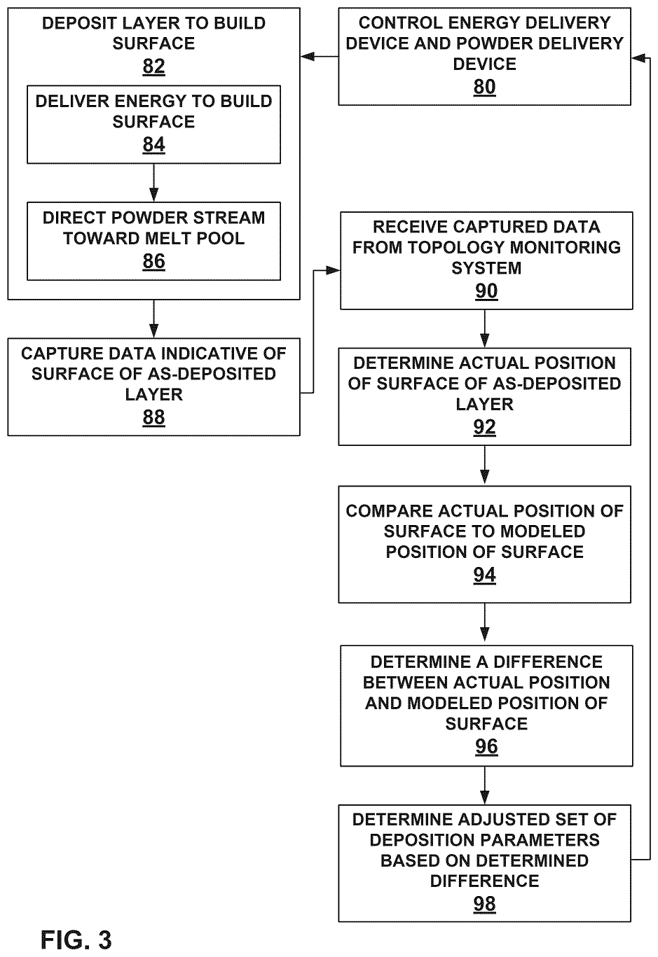

Computing device 12 is configured to analyze the sensor data, including the data from topology monitoring system 48, and control fabrication of a component based on the position of surface 36. Computing device 12 includes as-deposited surface module 64, which includes component model 68 and 3D surface module 65. Computing device 12 also includes an adaptive control module 66, which includes ML model 67. FIG. 3 is a flowchart illustrating an example additive manufacturing method for fabricating a component using data from topology monitoring system 48. Operation of computing device 12 will be described with respect to the method of FIG. 3. While computing device 12 will be described with respect to modules 64-68, it will be understood that various modules may be performed by other computing devices. For example, as-deposited surface module 64 and adaptive control module 66 may be part of separate computing devices, such as specialized computing devices for implementing topology monitoring and/or modelling and machine learning techniques.

The method includes controlling energy delivery device 16 and powder delivery device 14 (80). Adaptive control module 66 is configured to control energy delivery device 16 and powder delivery device 14 according to a set of deposition parameters which, as will be described further below, are at least partly based on data from topology monitoring system 48. For example, control module 66 may send control signals to energy delivery device 16 and powder delivery device 14 that control energy delivery device 16 and powder delivery device 14 to generate energy 34 and powder stream 30 according to particular parameters. As a result, energy delivery device 16 and powder delivery device 14 may deposit a layer on a build surface based on the control signals (82). For example, energy delivery device 16 may deliver energy to a build surface of a component to form a melt pool in the build surface of the component (84), and powder delivery device 14 may direct a powder stream toward the melt pool (86).

The method includes capturing data representative of the position of surface 36 of as-deposited layer 26 using topology monitoring system 48 (88). For example, topology monitoring system 48 may include 3D scanner 49 that captures image data of surface 36 and/or interferometer 51 that senses data from a laser striking surface 36. 3D scanner 49 and interferometer 51 may capture data indicative of the position of surface 36 at particular periods to generate a temporal representation of the position of surface 36, such that the image data may approximate video data or other image data having a temporal component. In some examples, topology monitoring system 48 may capture data at the conclusion of deposition of a layer, prior to deposition of the subsequent layer.

Computing device 12 may receive data indicative of the position of surface 36 from topology monitoring system 48 (90). In some examples, computing device 12 may receive the data as powder delivery device 14 and energy delivery device 16 deliver powder stream 30 and energy beam 34, respectively, to build surface 28. For example, the data may reflect conditions and position of surface 36 in real time, such that computing device 12 may use the data as immediate feedback. In some examples, computing device 12 may receive the sensor data after powder delivery device 14 and energy delivery device 16 deliver powder stream 30 and energy beam 34, respectively, to build surface 28. For example, image data may reflect the position of the entire surface 36 after deposition of as-deposited layer 26. In such cases, computing device 12 may use the data as feedback for adjusting operation of powder delivery device 14 and/or energy delivery device 16 to deposit the subsequent layer. In some examples, the method includes receiving additional sensor data, such as from at least one of optical system 54 or PFMS 18.

Computing device 12 may determine the actual position of surface 36 based on the received data (92). For example, as-deposited surface module 64 may include 3D surface module 65, which may be configured to generate a three-dimensional scan of surface 36 based on the received data from topology monitoring system 48. In examples where the received data is a single point, 3D surface module 65 may be configured to project the position of the remainder of surface 36 based on the single point (e.g., set all other points on surface 36 as in the same position in the Z-direction). Alternatively, where the received data is of multiple points on surface 36, 3D surface module 65 may be configured to stich together sensed positions of each point in a point cloud to determine the position of surface 36 (e.g., by connecting sensed points according to straight lines or curves).

Computing device 12 may compare the actual position of surface 36 to a modeled position of surface 36 stored in component model 68 of as-deposited surface module 64 (94). Component model 68 may include a CAD file of component 22, and may further include the desired position of the as-deposited surface at each layer 24, 26 as the build progresses to form the final version of component 22. Component model 68 may include a matrix which includes an ordinal order of layers, and store the corresponding positions of points on each layer. Additionally, component model 68 may include corresponding deposition parameters with each layer that are configured to produce layer 26 which has actual positions on surface 36 that match the modeled positions of surface 36 stored in the matrix.

Computing device 12 may determine a difference between the actual position of surface 36 and the modeled position of surface 36 stored in component model 68 (96). For example, computing device 12 may compare the generated 3D scan of the actual position of surface 36 to a modeled 3D scan of surface 36 stored in component model 68, and may calculate a distance between the actual and modeled positions at one or more points on surface 36 (e.g., at all points in a point cloud) to determine the difference between the actual and modeled positions.

Computing device 12 may determine an adjusted set of deposition parameters based on the determined difference (98). For example, adaptive control module 66 may be configured to correlate the deposition parameters and/or material parameters necessary to reduce or eliminate the distance between the actual position of surface 36 and the modeled position of surface 36 at each of a plurality of points on surface 36 (e.g., at all points in a point cloud). For example, parameters of the carrier gas, powder flow, energy flow, or deposition head, such as the travel speed of the deposition head along a toolpath, may influence the distance of difference between the actual position and the modeled position of surface 36. Adaptive control module 66 may adjust some or all of these deposition parameters to selectively tailor the deposition parameters at each point in the point cloud such that the actual position of surface 36 matches the modeled position of surface 36 in component model 68.

In some examples, adaptive control module 66 may correlate the determined difference with one or more deposition parameters controllable by powder delivery device 14 and/or energy delivery device 16. Adaptive control module 66 may be configured to analyze the determined difference between the actual and modeled positions of surface 36 with respect to deposition parameters and determine how a change in deposition parameters affects the difference between the actual and modeled positions of surface 36. Particular deposition parameters or locations on surface 36 may be associated with an increased difference between the actual and modeled position of surface 36. For example, a turbulent gas flow at melt pool 32 may cause reduced capture efficiency of powder stream 30 by melt pool 32, which may cause reduced thickness of as-deposited layer 26, and thus a difference between the actual position of surface 36 and the modeled position of surface 36. Adaptive control module 66 may be configured to identify the difference based on the data from topology monitoring system 48 and component model 68. The data may be used to analyze an effect of changing deposition parameters of powder delivery device 14 and/or energy delivery device 16.

In some examples, computing device 12 may be configured to use machine learning techniques to identify differences in the actual and modeled position of surface 36 as correlating to certain deposition parameters, and/or to determine adjustments to deposition parameters that result in a reduction of the determined difference. Such machine learning techniques may enable computing device 12 to adapt and optimize deposition parameters using the observed actual position of surface 36 as indicated by the data from topology monitoring system 48.

In some examples, ML model 67 may be configured to correlate the determined difference with the one or more deposition parameters using one or more machine learning techniques. ML model 67 may be configured to determine one or more deposition parameters based on observed behavior indicated by the data using model-based reinforcement learning. ML model 67 may be configured to learn a model of deposition behavior based on data from topology monitoring system 48 and use this model to make decisions about an effect of one or more deposition parameters or change in one or more deposition parameters.

ML model 67 may identify one or more deposition parameters related to powder delivery device 14 such as one or more of a carrier gas flow rate, a powder flow rate, or a delivery nozzle position, shape, or other parameter of powder delivery device 14. Similarly, ML model 67 may identify one or more deposition parameters related to energy delivery device 16 such as a power or focus of energy delivery device 16. ML model 67 may further receive the data from monitoring system 48 and identify ways that a difference between the actual position and the modeled position may be reduced (e.g., producing a smaller difference distance) or eliminated.

ML model 67 may include, but is not limited to, reinforcement learning models, such as deep reinforcement learning algorithms or traditional reinforcement learning algorithms. ML model 67 may train the machine learning model using the actual position of surface 36 and the modeled position of surface 36. The model may learn the underlying patterns and relationships between the deposition parameters and the observed behavior as indicated by the difference between the actual and modeled position of surface 36. For example, ML model 67 may operate the model to improve a reward signal associated with a reduced distance between the actual and modeled position of surface 36.

ML model 67 may determine improved deposition parameters for a given set of conditions. For example, ML model 67 may use optimization methods, such as gradient-based methods or evolutionary algorithms, to tune the deposition parameters. ML model 67 may further validate the model by analyzing the differences between actual position of surface 36 and modeled position of surface 36 of as-deposited layer 26 during fabrication of subsequent layers and/or components.

ML model 67 may identify one or more parameters that results from or are correlated with a determined difference between an actual and modeled position of surface 36. ML model 67 may further receive sensor information that provides indication of such parameters, such as temperature data of melt pool 32, a travel speed of a deposition head along a toolpath, or any other data that may provide an indication of process conditions. As described above, the data input into ML model 67 may include any combination of data from topology monitoring system 48, parameters determined from the data, other sensed data from system 10, or various settings of system 10.

ML model 67 may determine improved deposition parameters for a given set of conditions. For example, ML model 67 may use optimization methods, such as gradient-based methods or evolutionary algorithms, to tune the deposition parameters. ML model 67 may further validate the model by analyzing determined differences between an actual position and a modeled position of surface 36 of as-deposited layer 26 during fabrication of other layers and/or components, and the resulting build quality that results from reduction or elimination of the difference.

For example, the deposition parameters may be updated to deposit a reduced amount of material on high areas of a previous layer and deposit a reduced amount of material on low areas of the previous layer. Adaptive control module 66 may determine the adjusted parameters based at least partially on outputs from machine learning model 67. For example, adaptive control module 66 may generate control signals that cause powder delivery device 14 to modify any of a powder flow rate, a carrier gas flow rate, a delivery nozzle position or angle, or other parameter related to a velocity, directionality, or composition of the flow of powder stream 30 to achieve a powder stream that reduces or eliminates a difference between an actual position of surface 36 and a modeled position of surface 36. Similarly, adaptive control module 66 may generate control signals that cause energy delivery device 16 to modify any of a power, focus (beam diameter), working distance, pulse rate, dwell time, polarity, or other parameter related to a power, directionality, or wavelength of energy 34 to achieve an energy beam that reduces or eliminates a determined difference between the actual position of surface 36 and modeled position of surface 36.

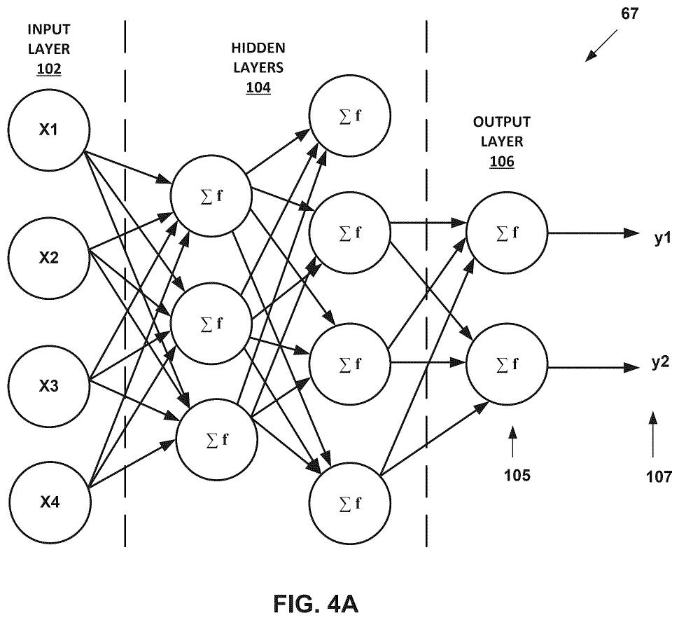

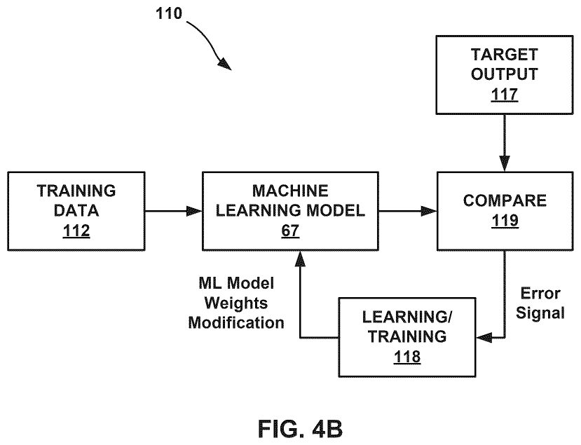

As explained in FIG. 1B with respect to ML model 67, additive manufacturing systems described herein may be configured to use machine learning processes for determining a relationship between a determined difference in an actual position and a modeled position of surface 36 and various upstream deposition parameters that cause the determined difference downstream parameters of component 22 that result from the determined difference. FIG. 4A is a conceptual diagram illustrating an example machine learning model according to one or more aspects of this disclosure. ML model 67 may be an example of a deep learning model, or deep learning algorithm, trained to determine deposition parameters, material parameters, or component dimensions associated with or influenced by a difference between an actual position and a modeled position of surface 36. Computing device 12 and/or another device, may train, store, and/or utilize ML model 67, but other devices of system 10 may apply inputs to ML model 67. In some examples, other types of machine learning and deep learning models or algorithms may be utilized. For example, a convolutional neural network model of ResNet-18 may be used. Some non-limiting examples of models that may be used for transfer learning include AlexNet, VGGNet, GoogleNet, ResNet50, or DenseNet, etc. Some non-limiting examples of machine learning techniques include Support Vector Machines, K-Nearest Neighbor algorithm, and Multi-layer Perceptron.

As shown in the example of FIG. 4A, ML model 67 may include three types of layers. These three types of layers include input layer 102, hidden layers 104, and output layer 106. Output layer 106 includes the output from the transfer function 105 of output layer 106. Input layer 102 represents each of the input values X1 through X4 provided to ML model 67. In some examples, the input values may include any of the values input into the machine learning model, as described above. For example, the input values may include data from topology monitoring system 48, various settings and parameters of powder delivery device 14, various settings and parameters of energy delivery device 16, various parameters related to component 22, or another other data received by computing device 12, as described above.

Each of the input values for each node in the input layer 102 is provided to each node of a first layer of hidden layers 104. In the example of FIG. 4A, hidden layers 104 include two layers, one layer having four nodes and the other layer having three nodes, but fewer or greater number of nodes may be used in other examples. Each input from input layer 102 is multiplied by a weight and then summed at each node of hidden layers 104. During training of ML model 67, the weights for each input are adjusted to establish a relationship between data from topology monitoring system 48 and deposition parameters that generate a difference between the actual and modeled positions of surface 36. In some examples, one hidden layer may be incorporated into ML model 67, or three or more hidden layers may be incorporated into ML model 67, where each layer includes the same or different number of nodes.

The result of each node within hidden layers 104 is applied to the transfer function of output layer 106. The transfer function may be linear or non-linear, depending on the number of layers within machine learning model 67. Example non-linear transfer functions may be a sigmoid function or a rectifier function. The output 107 of the transfer function may be a set of deposition parameters, or a set of material parameters, that correspond to a reduced difference between actual and modeled positions of surface 36. As shown in the example above, by applying ML model 67 to input data such as data from topology monitoring system 48, processing circuitry of computing device 12 is able to determine a relationship between deposition parameters that produce, and/or component dimensions that result from, the difference between the actual and modeled positions of surface 36 based on the data from topology monitoring system 48.

FIG. 4B is a conceptual diagram illustrating an example training process for a machine learning model according to one or more aspects of this disclosure. Process 110 may be used to train machine learning model 67. Machine learning model 67 may be implemented using any number of models for supervised and/or reinforcement learning, such as but not limited to, an artificial neural network, a decision tree, naïve Bayes network, support vector machine, or k-nearest neighbor model, CNN, RNN, LSTM, ensemble network, to name only a few examples.

In some examples, computing device 12 or another device trains machine learning model 67 based on a corpus of training data 112. Training data 112 may include, for example, image data of previous builds, for examples previous data of differences between actual and modeled positions of surface 36 that did not meet a threshold for causing dimensions of component 22 to fall outside a specification window, previous deposition parameters or material parameter data, and/or the like. Previous deposition parameter or material parameter data, for example, may include deposition parameters or material parameters associated with previous additive manufacturing processes. In some examples, the data and/or deposition parameter or material parameter data may be generated by executing a natural language processing application on content of a plurality of operational records to automatically extract relevant nor desired training data. For example, by using an NLP model, computing device 12 may capture potentially cofounding operation conditions or factors, which may be useful in determining a set of deposition parameters. Computing device 12 may use the NLP model to capture such details. In such an example, the machine learning model may analyze underlying characteristics associated with the powder, rather than powder flow factors, when determining a set of deposition parameters.

In some examples, training data 112 may include annotations identifying effects of deposition parameters indicated in image data of training data 112. Training data 112 may include data from past additive deposition processes performed on components having different geometries, formed from different materials, formed under different conditions, and/or the like.

While training ML model 67, computing device 12 may compare 119 a prediction or classification with a target output 117. Computing device 12 may utilize an error signal from the comparison to train (learning/training 118) ML model 67. Computing device 12 may generate machine learning model weights or other modifications which computing device 12 may use to modify ML model 67. For example, computing device 12 may modify the weights of ML model 67 based on the learning/training 118.

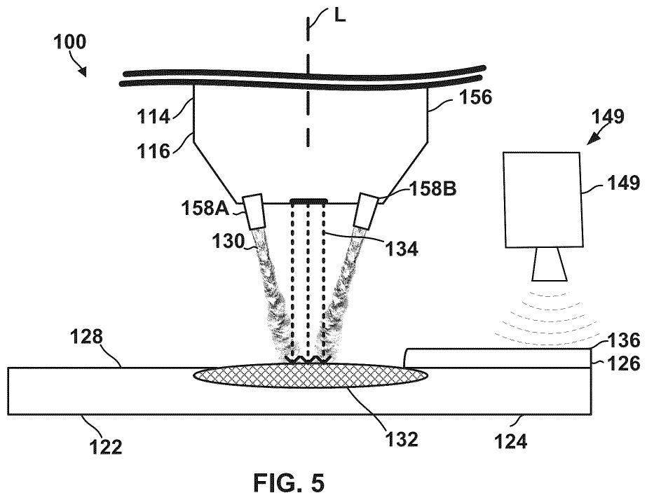

FIG. 5 is a conceptual and schematic diagram illustrating a portion of an example additive manufacturing system 100 during an additive manufacturing technique. Additive manufacturing system 100 of FIG. 5 may be an example of additive manufacturing system 10 of FIGS. 1A and 1B. Similar reference numerals indicate similar elements. Portions of additive manufacturing system 100 are not included in FIG. 5. These portions will be described with respected to additive manufacturing system 10 of FIG. 1A and 1B.

Additive manufacturing system 100 includes deposition head 156, of which both energy delivery device 116 and powder delivery device 114 are components. In the illustrated example, energy delivery device 116 includes a laser mounted above or housed in a cavity within deposition head 156. Energy delivery device 116 delivers energy beam 134 through an opening in deposition head 156 to form melt pool 132 on build surface 128 of previously deposited layer 124 of component 122.

Powder delivery device 114 includes channels (not illustrated for clarity) formed within the wall of deposition head 156. The channels are fluidically connected to delivery nozzles 158A, 158B (collectively “delivery nozzles 158”) from which powder stream 130 is directed to melt pool 132, adding material to melt pool 132 to form as-deposited layer 126. As-deposited layer 126 defines surface 136.

Additive manufacturing system 100 includes 3D scanner 149, which is all or a portion of topology monitoring system 148. 3D scanner 149 is configured to image a portion of surface 136, and computing device 12 is configured to determine a position of surface 136 based on the captured image. Computing device 12 may compare the determined position of surface 136 to a modeled position of surface 136, and may control various aspects of system 100 based on the results of the comparison, as described above.

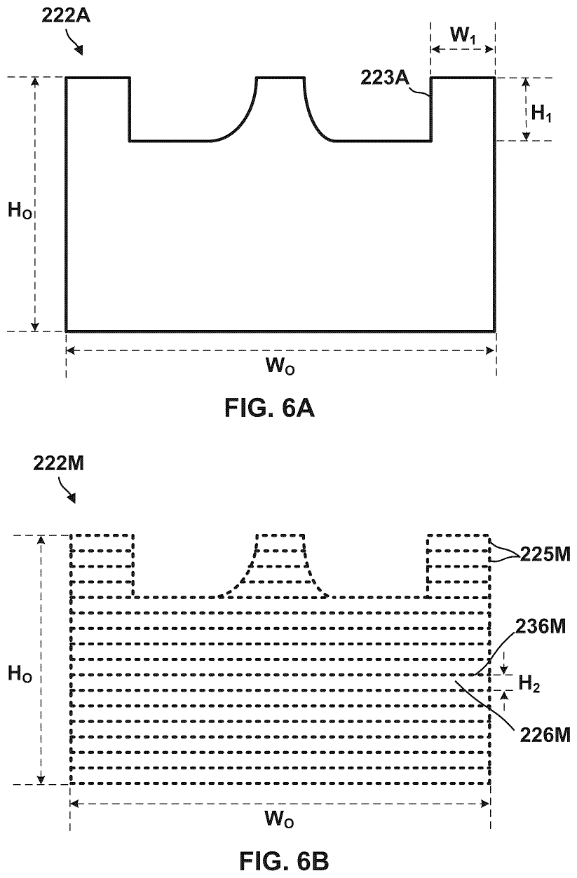

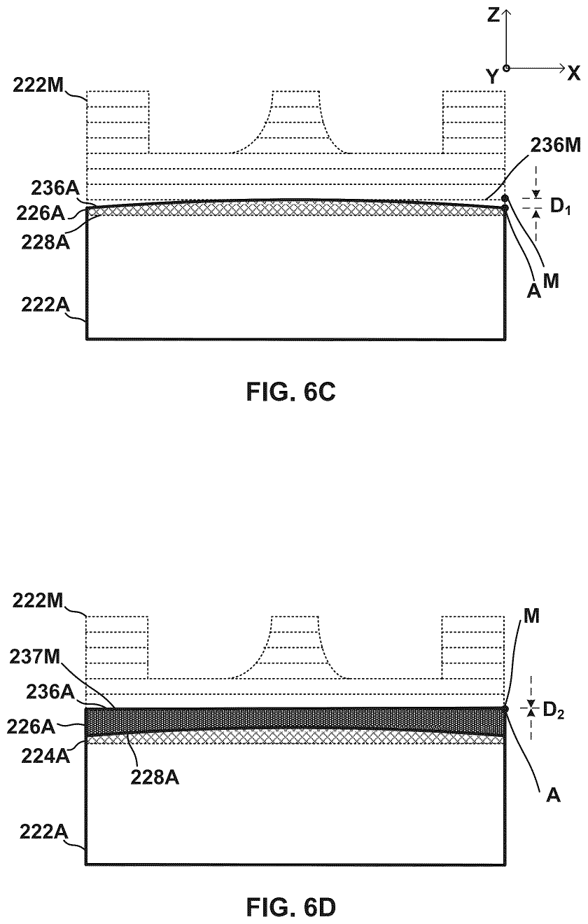

FIGS. 6A-6D are conceptual and schematic diagram illustrating fabrication of an example component 22A during an additive manufacturing technique that employs in-situ comparison to a model of the component and control based on the difference between the actual component and the model. Elements of the actual component 222A being manufactured are labeled with an “A”. Elements of model component 222M stored in component model 68 of computing device 12 are labeled with an “M.”

FIG. 6A illustrates example finished component 222A, which may be fabricated by system 10 according to techniques of the present disclosure. Final component 222A includes overall dimensions Ho and Wo. Final component 222A also includes feature 223A, which includes dimensions H₁ and W₁.

FIG. 6B illustrates model component 222M, which may be stored as a portion of component model 68 by computing device 12. Model component 222M includes layers 225M configured to make up model component 222M. Model component 222M includes overall dimensions Ho and Wo. Model component 222M may also include a position of modeled surface 236M of layer 226M making up model component 222M. Accordingly, model 222M may define thickness H₂ of 226M.

FIG. 6C illustrates comparison of actual component 222A during fabrication with model component 222M for comparison by computing device 12. System 10 may deposit as-deposited layer 226A on build surface 228A. Computing device 12 may compare the position of surface 226A to the position of modeled surface 236M. Computing device 12 may determine a difference D₁ between a position of surface 236A of actual component 222A and the position of modeled surface 236M. Although FIG. 6C illustrates comparison and determination of the difference in the Z-direction, the difference may be determined along another axis in cases where the build direction is along that axis. Furthermore, although FIG. 6C illustrates comparison between point A on actual surface 236A and point M at the corresponding location in the X-Y plane on modeled surface 236M to determine difference D₁, it is understood that computing device 12 may perform evaluation of the difference at each point of a grid in the X-Y plane, and thus determine differences at each location on the grid.

FIG. 6D illustrates deposition by system 10 of the layer subsequent to the layer deposited in FIG. 6C. Accordingly, the layer deposited in FIG. 6C retains the cross-hatching pattern as in FIG. 6C, but is renamed base layer 224A because the subsequent layer is being deposited on build surface 228A as the as-deposited layer 226A. Since as-deposited layer 226A is advanced one level, the surface to which surface 236A is compared to in component model 68 has advanced one level to surface 237M. Computing device 12 of system 10 may employ control techniques according to the present disclosure compare the position of surface 236A to surface 237M to reduce the determined difference between point A on surface 236A and point M on surface 237M to distance D₂. As illustrated, computing device 12 may cause distance D₂ to be zero, and may thus eliminate the difference between the actual and modeled positions of the surface. In this way, computing device 12 may bring the build back under control. The additive manufacturing process may continue, depositing layers until final finished component 222A is produced with dimensions H_{O}, W_{O}, H₁, and W₁ that match (e.g., fall within a specification window) of the dimensions of component model 222M. In this way, systems and techniques of the present disclosure may reduce material waste and/or may reduce rework by in-situ comparison to a model and adjustment based on determined differences between the actual component being fabricated and the model component.

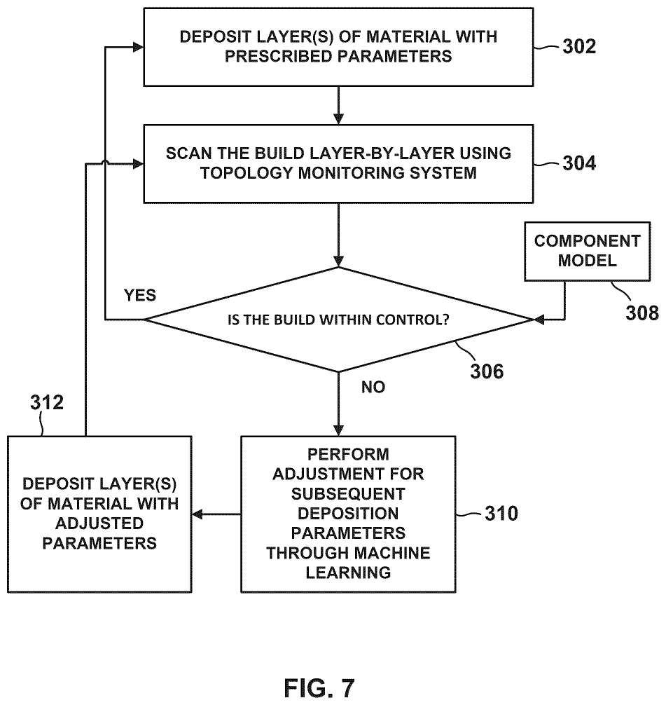

FIG. 7 is a flowchart illustrating an example technique according to the present disclosure. The technique of FIG. 7 may be performed by system 10 of FIGS. 1A and 1B, or by system 100 of FIG. 5. The technique may also be performed by other systems, and the described systems may perform other techniques. The technique of FIG. 7 is described with respect to system 10 of FIGS. 1A and 1B.

Computing device 12 may cause energy delivery device 16 and powder delivery device 14 to deposit layers 25 with prescribed deposition parameters (302). After deposition of as-deposited layer 26, computing device 12 may cause topology monitoring system 48 to capture data indicative of a position of surface 36 (304). For example, computing device 12 may cause 3D scanner 49 to capture image data representative of the entire area of surface 36.

Next, computing device 12 may determine whether the build is in control (306). For example, computing device 12 generate a three-dimensional scan of surface 36 and may compare the generated scan indicative of the actual position of surface 36 to a position of surface 36 in component model 68 (308). In some examples, computing device 12 may determine whether the difference between the actual of modeled positions of surface 36 exceeds a threshold difference. Responsive to determining that the difference does not exceed a threshold difference, computing device 12 may determine that the build is within control (YES). Computing device 12 may cause system 10 to deposit additional layers of material with prescribed deposition parameters (302).

Responsive to determining that the actual and modeled positions of surface 36 exceeds a threshold difference, computing device 12 may determine that that the build is not in control (NO). Computing device 12 may adjust deposition parameters for subsequent layers (310). In some examples, the adjustments may be based on outputs from ML model 67. Computing device 12 may then cause system 10 to deposit an additional layer or layers of material with the adjusted deposition parameters (312). After deposition of the layer or layers, computing device 12 may cause topology monitoring system 48 to capture data indicative of the surface of the additional layers (304). The technique of FIG. 7 may continue until component 22 is completely fabricated.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following examples and claims.

Example 1: An additive manufacturing system includes an energy delivery device configured to deliver energy to a build surface of a component to form a melt pool in the build surface of the component; a powder delivery device configured to direct a powder stream toward the melt pool to form an as-deposited layer on the build surface; a topology monitoring system configured to capture data indicative of a position of a surface of the as-deposited layer; and a computing device configured to: receive the captured data from the topology monitoring system, determine an actual position of the surface of the as-deposited layer based on received data from the topology monitoring system, compare the actual position of the surface of the as-deposited layer to a modeled position of the surface of the as-deposited layer; determine a difference between the actual position and the modeled position of the as-deposited layer; and control at least one of the energy delivery device or the powder delivery device based on the difference between the actual position and the modeled position of the as-deposited layer.

Example 2: The additive manufacturing system of example 1, wherein, to control at least one of the energy delivery device or the powder delivery device, the computing device is configured to: compare the determined difference between the actual position and the modeled position of surface to a threshold difference; and responsive to determining that the determined difference exceeds the threshold difference, adjust one or more deposition parameters of the energy delivery device or the powder delivery device.

Example 3: The additive manufacturing system of example 2, wherein, to adjust the one or more deposition parameters, the computing device is configured to adjust the one or more deposition parameters to reduce a distance between the actual position and the modeled position of the as-deposited layer.

Example 4: The additive manufacturing system of any of examples 1 through 3, wherein the computing device is configured to generate a three-dimensional scan of the surface of the as-deposited layer.

Example 5: The additive manufacturing system of example 4, wherein the topology monitoring system includes at least one of a computed tomography device, a structured-light device, a LIDAR device, or a time-of-flight camera device.

Example 6: The additive manufacturing system of any of examples 1 through 5, wherein the powder delivery device and the energy deliver device are parts of a common deposition head.

Example 7: The additive manufacturing system of any of examples 1 through 6, wherein the computing device is configured to control the powder delivery device according to a set of deposition parameters that includes one or more deposition parameters controllable by the powder delivery device, wherein the set of deposition parameters controllable by the powder delivery device include one or more of a carrier gas flow rate, a powder mass flow rate, and a delivery nozzle angle.

Example 8: The additive manufacturing system of example 7, wherein the computing device is further configured to: determine one or more deposition parameters controllable by the powder delivery device; and control, based on the one or more deposition parameters, the powder delivery device.

Example 9: The additive manufacturing system of example 8, wherein the computing device is configured to determine, based on output of a machine learning model that takes captured data from the topology monitoring system as input, the one or more deposition parameters.

Example 10: The additive manufacturing system of any of examples 1 through 9, wherein the computing device is configured to control the energy delivery device according to a set of deposition parameters that includes one or more deposition parameters controllable by the energy delivery device, wherein the set of deposition parameters controllable by the energy delivery device include one or more of a focus of the energy delivery device, a scan speed of the energy delivery device, and a power supplied to the energy delivery device.

Example 11: The additive manufacturing system of any of examples 8 through 10, wherein the computing device is further configured to: determine one or more deposition parameters controllable by the energy delivery device; and control, based on the one or more deposition parameters, the energy delivery device.

Example 12: The additive manufacturing system of any of examples 1 through 11, further comprising the component, wherein the component is a gas turbine engine component.

Example 13: A method for additive manufacturing includes delivering, via an energy delivery device of an additive manufacturing system, energy to a build surface of a component to form a melt pool in the build surface of the component; delivering, via a powder delivery device of the additive manufacturing system, a powder stream toward the melt pool to form an as-deposited layer on the build surface, receiving, by a computing device, data indicative of a position of a surface of the as-deposited layer from a topology monitoring system; determining, by the computing device, an actual position of the surface of as-deposited layer based on the received data; comparing, by the computing device, the actual position of the surface of the as-deposited layer to a modeled position of the surface of the as-deposited layer; determining, by the computing device, a difference between the actual position and the modeled position of the as-deposited layer; and controlling, by the computing device and based on the determined difference between the actual position and the modeled position of the as-deposited layer, at least one of the powder delivery device or the energy delivery device.

Example 14: The method of example 13, wherein comparing the actual position of the surface of the as-deposited layer to the modeled position of the layer comprises storing a model of the component, wherein the component includes a plurality of layers, and wherein the model includes positions of each as-deposited layer and deposition parameters for each layer of the plurality of layers.

Example 15: The method of any of examples 13 and 14, wherein controlling at least one of the energy delivery device or the powder delivery device comprises comparing the determined difference between the actual position and the modeled position of surface to a threshold difference; and responsive to determining that the determined difference exceeds the threshold difference, adjusting one or more deposition parameters of the energy delivery device or the powder delivery device.

Example 16: The method of example 15, wherein adjusting the deposition parameters of the powder delivery device or the energy delivery device reduces a distance between the actual position and the modeled position of the as-deposited layer.

Example 17: The method of example 16, wherein adjusting the deposition parameters of the powder delivery device or the energy delivery device comprises adjusting the deposition parameters of both the powder delivery device and the energy delivery device.

Example 18: The method of any of examples 13 through 17, further comprising generating, by the computing device, a three-dimensional scan of the surface of the as-deposited layer.

Example 19: The method of any of examples 17 and 18, wherein the topology monitoring system includes at least one of a computed tomography device, a structured-light device, a LIDAR device, or a time-of-flight camera device.

Example 20: The method of any of examples 15 through 19, wherein the computing device is configured to determine, based on output of a machine learning model that takes captured data from the topology monitoring system as input, the one or more deposition parameters.

What is claimed is:

1. An additive manufacturing system, comprising:
an energy delivery device configured to deliver energy to a build surface of a component to form a melt pool in the build surface of the component;
a powder delivery device configured to direct a powder stream toward the melt pool to form an as-deposited layer on the build surface;
a topology monitoring system configured to capture data indicative of a position of a surface of the as-deposited layer; and
a computing device configured to:
receive the captured data from the topology monitoring system,
determine an actual position of the surface of the as-deposited layer based on received data from the topology monitoring system,
compare the actual position of the surface of the as-deposited layer to a modeled position of the surface of the as-deposited layer;
determine a difference between the actual position and the modeled position of the as-deposited layer; and
control at least one of the energy delivery device or the powder delivery device based on the difference between the actual position and the modeled position of the as-deposited layer.

2. The additive manufacturing system of claim 1, wherein, to control at least one of the energy delivery device or the powder delivery device, the computing device is configured to:
compare the determined difference between the actual position and the modeled position of surface to a threshold difference; and
responsive to determining that the determined difference exceeds the threshold difference, adjust one or more deposition parameters of the energy delivery device or the powder delivery device.

3. The additive manufacturing system of claim 2, wherein, to adjust the one or more deposition parameters, the computing device is configured to adjust the one or more deposition parameters to reduce a distance between the actual position and the modeled position of the as-deposited layer.

4. The additive manufacturing system of claim 1, wherein the computing device is configured to generate a three-dimensional scan of the surface of the as-deposited layer.

5. The additive manufacturing system of claim 4, wherein the topology monitoring system includes at least one of a computed tomography device, a structured-light device, a LIDAR device, or a time-of-flight camera device.

6. The additive manufacturing system of claim 1, wherein the powder delivery device and the energy deliver device are parts of a common deposition head.

7. The additive manufacturing system of claim 1, wherein the computing device is configured to control the powder delivery device according to a set of deposition parameters that includes one or more deposition parameters controllable by the powder delivery device, wherein the set of deposition parameters controllable by the powder delivery device include one or more of a carrier gas flow rate, a powder mass flow rate, and a delivery nozzle angle.

8. The additive manufacturing system of claim 7, wherein the computing device is further configured to:
determine one or more deposition parameters controllable by the powder delivery device; and
control, based on the one or more deposition parameters, the powder delivery device.

9. The additive manufacturing system of claim 8, wherein the computing device is configured to determine, based on output of a machine learning model that takes captured data from the topology monitoring system as input, the one or more deposition parameters.

10. The additive manufacturing system of claim 1, wherein the computing device is configured to control the energy delivery device according to a set of deposition parameters that includes one or more deposition parameters controllable by the energy delivery device, wherein the set of deposition parameters controllable by the energy delivery device include one or more of a focus of the energy delivery device, a scan speed of the energy delivery device, and a power supplied to the energy delivery device.

11. The additive manufacturing system of claim 8, wherein the computing device is further configured to:
determine one or more deposition parameters controllable by the energy delivery device; and
control, based on the one or more deposition parameters, the energy delivery device.

12. The additive manufacturing system of claim 1, further comprising the component, wherein the component is a gas turbine engine component.

13. A method for additive manufacturing, comprising:
delivering, via an energy delivery device of an additive manufacturing system, energy to a build surface of a component to form a melt pool in the build surface of the component;
delivering, via a powder delivery device of the additive manufacturing system, a powder stream toward the melt pool to form an as-deposited layer on the build surface,
receiving, by a computing device, data indicative of a position of a surface of the as-deposited layer from a topology monitoring system;
determining, by the computing device, an actual position of the surface of as-deposited layer based on the received data;
comparing, by the computing device, the actual position of the surface of the as-deposited layer to a modeled position of the surface of the as-deposited layer;
determining, by the computing device, a difference between the actual position and the modeled position of the as-deposited layer; and
controlling, by the computing device and based on the determined difference between the actual position and the modeled position of the as-deposited layer, at least one of the powder delivery device or the energy delivery device.

14. The method of claim 13, wherein comparing the actual position of the surface of the as-deposited layer to the modeled position of the layer comprises storing a model of the component, wherein the component includes a plurality of layers, and wherein the model includes positions of each as-deposited layer and deposition parameters for each layer of the plurality of layers.

15. The method of claim 13, wherein controlling at least one of the energy delivery device or the powder delivery device comprises comparing the determined difference between the actual position and the modeled position of surface to a threshold difference; and
responsive to determining that the determined difference exceeds the threshold difference, adjusting one or more deposition parameters of the energy delivery device or the powder delivery device.

16. The method of claim 15, wherein adjusting the deposition parameters of the powder delivery device or the energy delivery device reduces a distance between the actual position and the modeled position of the as-deposited layer.

17. The method of claim 16, wherein adjusting the deposition parameters of the powder delivery device or the energy delivery device comprises adjusting the deposition parameters of both the powder delivery device and the energy delivery device.

18. The method of claim 13, further comprising generating, by the computing device, a three-dimensional scan of the surface of the as-deposited layer.

19. The method of claim 17, wherein the topology monitoring system includes at least one of a computed tomography device, a structured-light device, a LIDAR device, or a time-of-flight camera device.

20. The method of claim 15, wherein the computing device is configured to determine, based on output of a machine learning model that takes captured data from the topology monitoring system as input, the one or more deposition parameters.
